(19) United States
(12) Patent Application Publication
(10) Pub. No.: US 2010/0035755 A1
(43) Pub. Date: Feb. 11, 2010

(54) METHOD OF CONTROLLING WEEDS IN A TURF GRASS BY USING SULFONYLUREA COMPOUNDS

(75) Inventors: Suk-Jin Koo, Daejeon (KR); Ki-Hwan Hwang, Daejeon (KR); Man-Seok Jeon, Daejeon (KR); Sung-Heon Kim, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Moghu Research Center Ltd., Daejeon (KR)

(21) Appl. No.: 12/535,651

(22) Filed: Aug. 4, 2009

(30) Foreign Application Priority Data
Aug. 7, 2008 (KR) 10-2008-0077249

(51) Int. Cl. A01N 47/36; A01P 13/00

(52) U.S. Cl. 504/213; 504/214; 504/212; 504/215

(57) ABSTRACT

The present invention relates to a method of controlling weeds in a turf grass using a sulfonylurea compound. More specifically, the present invention relates to a turf grass herbicide which comprises as an effective component a benzene sulfonylurea derivative compound that is represented by the Formula (I), or a thiophene sulfonylurea derivative compound that is represented by the Formula (II), and a method of controlling selectively poaceae, cyperaceae and broadleaf weeds by using the sulfonylurea compounds.

### DETAILED DESCRIPTION OF THE INVENTION

### FIELD OF THE INVENTION

The present invention relates to a method of controlling weeds in a turf grass by using a benzene sulfonylurea derivative compound that is represented by the Formula (I), or a thiophene sulfonylurea derivative compound that is represented by the Formula (II).

### BACKGROUND ART

Various kinds of sulfonylurea compound have been known as an herbicide and used in an agricultural field. For example, in U.S. Pat. No. 4,332,611, the compounds that are represented by the following Formula (a) have been disclosed.

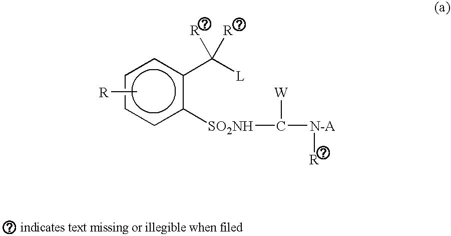

(wherein, L indicates OH,

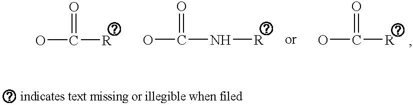

R indicates H, F, Cl, Br, NO₂, CF₃, a C₁-C₃ alkyl group or a C₁-C₃ alkoxy group, R¹ indicates H, or a C₁-C₄ alkyl group, R¹ indicates H, or CH₃, R⁸ indicates H, CH₃ or OCH₃, R¹¹ indicates H, a C₁-C₅ alkyl group, a C₂-C₃ alkenyl group, or a C₂-C₃ alkynyl group, and A represents pyrimidine or triazine group).

Further, in U.S. Pat. No. 4,786,314, the compounds that are represented by the following Formula (b) have been disclosed.

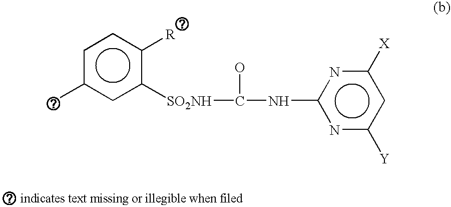

(wherein R¹ indicates, F, Cl, Br, NO₂, a C₁-C₄ alkyl group, a C₂-C₄ alkenyl group, a C₂-C₄ haloalkenyl group, a C₂-C₄ alkynyl group, a C₁-C₄ haloalkyl group, a C₁-C₄ alkoxy group, or a C₁-C₂ alkyl group substituted with OH, alkoxy, alkylthio, phenyl, CH₂CN, R² indicates

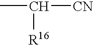

and the like (wherein R¹⁶ indicates an alkyl group), X indicates an alkyl group, an alkoxy group and the like, and Y indicates an alkyl group, an alkoxy group, a halogen and the like).

Further, in U.S. Pat. No. 4,838,926, the compounds that are represented by the following Formula (c) have been disclosed.

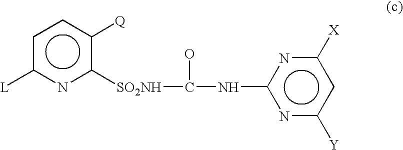

(wherein, Q indicates a C₁-C₄ alkyl group substituted with R², R² indicates OR³,

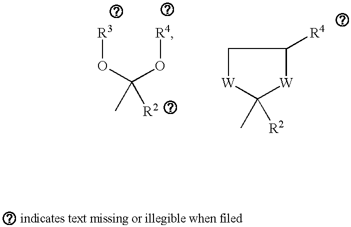

and the like,

R³ indicates H, a C₁-C₄ alkyl group, an alkenyl group, an alkynyl group, a haloalkyl group and the like, L indicates

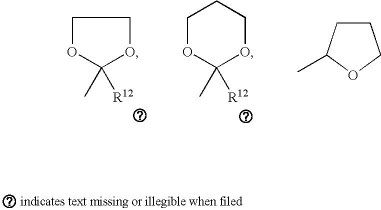

and the like and

R¹² indicates H or CH₃).

Further, in European Patent No. 125,205, the compounds that are represented by the following Formula (d) have been disclosed.

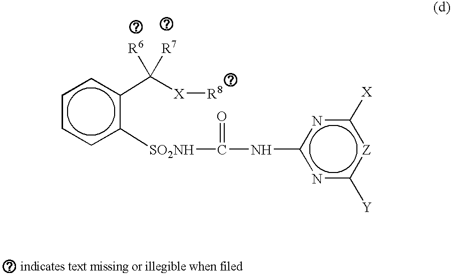

(wherein R⁶ indicates H, an alkyl group, or F, R⁷ indicates H or CH₃, X¹ indicates O or S, R⁸ indicates a haloalkyl group or an alkoxyalkyl group).

Further, in Korean Patent Registration No. 10-70675, the benzene sulfonylurea compounds that are represented by the following Formula (I) have been disclosed

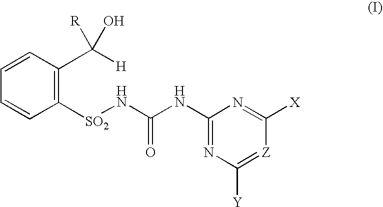

(wherein R indicates a haloalkyl group, X and Y, which are the same or different to each other, independently represent CH₃, OCH₃, Cl, etc. and Z indicates CH or N).

Still her, in U.S. Pat. No. 5,461,024, the thiophene sulfonylurea compounds that are represented by the following Formula (II) have been disclosed.

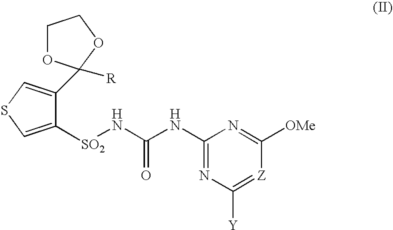

(wherein R indicates a C₁-C₆ alkyl group which is substituted with 1 to 3 halogen atoms, Y indicates CH₃ or OCH₃ and Z indicates CH or N).

Meanwhile, agricultural chemicals are broadly classified into those used for crops (i.e., agricultural field) and those for non-agricultural field. Specifically, those used for crops are applied to grains such as rice, wheat, soy bean, corn and the like, and various kinds of vegetables and fruits, while those used for non-agricultural field are applied to forest, landscape, railroad side, etc. For an agricultural field, tillage and crop cultivation are carried out regularly. On the other hand, non-agricultural field is often left as it is or managed very differently from an agricultural field. For such reasons, use of an herbicide is quite different. Although sulfonylurea compounds are mainly used for an agricultural field, as having high crop selectivity, some sulfonylurea herbicides are applied to a turf grass, which is a non-agricultural field. Turf grass grown in a garden, a golf course, or landscape, etc. has a short mowing height, and therefore is disadvantageous for competing with other weeds. As a result, in a turf grass field, weeds can easily thrive and the type of the weeds is different compared to a typical agricultural field. In addition, since a turf grass is perennially maintained without any tillage, there can be a lot of perennial weeds, too.

Sulfonylurea type herbicides that are mostly applied to a turf grass instead of a crop are exemplified in the following Table 1.

TABLE 1

| Name | Structure | Pat. No. |
|---|---|---|
| Flazasulfuron (R. 1) | 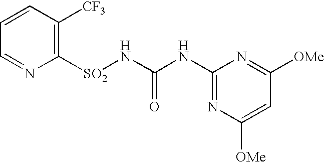 | WO94/23063 |
| Trifloxysulfuron (R. 2) | 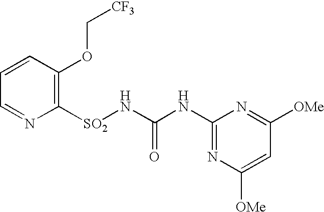 | WO92/16522 |
| Halosulfuron-methyl (R. 3) | 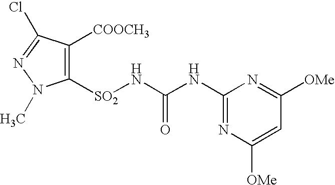 | JP60208977 |
| Cyclosulfamuron (R. 4) | 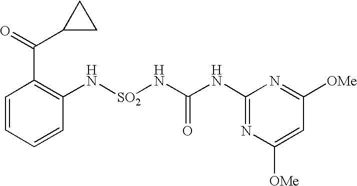 | WO92/00952 |

The above-exemplified sulfonylurea herbicides for a turf grass can be divided into two separate categories. The compound Nos. R. 1 and R. 2 are useful for controlling Poa annua, which is a weed belonging to poaceae, and have a safety to warm season turf grass including zoysiagrass (Zoysia japonica and Zoysia matrella) and Burmudagrass (Cynodon dactylon) warm season turf. However, they have no safety to cool season turf grass such as creeping bentgrass (Agrostris palustris) and Kentucky bluegrass (Poa pratensis) cool season turf. Since a tee box area or putting greens of a golf course mostly consist of creeping bentgrass and Kentucky bluegrass, the above compound Nos. R. 1 and R. 2 cannot be applied to a tee box area or for a putting green. Instead, they can be used only for a fairway consisting of warm season turf grass such as Zoysia japonica, Zoysia matrella and the like. However, the herbicides applied to a fairway can be carried by a golfer's shoes and may damage severely the putting greens. As such, use of the above compound Nos. R. 1 and R. 2 is significantly limited.

On the other hand, unlike the above compound Nos. R. 1 and R. 2, the above compound Nos. R. 3 and R. 4 are safe not only to a warm season turf grass but also to a cool season turf grass. However, they are ineffective of controlling grass weeds such as Poa annua, and Digitaria sanguinalis, which are the most problematic weeds for a turf grass, and therefore they can be used only for the control of broad leaf weeds and cyperaceae weeds.

Disclosure of the Invention

Problems to be Solved by the Invention

The present invention was devised in view of the above. Specifically, while determining various kinds of sulfonylurea compounds which have not been commercialized yet to solve the above described problems associated with existing sulfonylurea turf herbicides, inventors of the present invention found that the compounds that are represented by the following Formula (I) or (II) have an excellent safety to a turf grass and herbicidal activity compared to existing sulfonylurea turf herbicides. Korean Patent Registration No. 10-70675 and U.S. Pat. No. 5,461,024 in which the compounds of the Formula (I) or the Formula (II) are disclosed, respectively, do not describe at all about their use as a turf grass herbicide and evaluation thereof. In this regard, the inventors of the present invention identified characteristics and superiority of the compounds of the Formula (I) and the Formula (II) as a turf grass herbicide over existing sulfonylurea herbicides. Consequently, a method of using the compounds as a turf grass herbicide was figured out, and therefore the present invention was completed.

Means for Solving the Problems

In order to solve the problems that are described in the above, the present invention provides a method for the selective control of poaceae, cyperaceae and broadleaf weeds comprising treating a warm season turfgrass or a cool season turfgrass with the benzene sulfonylurea derivative compounds represented by the following Formula (I), pre- or post-emergence.

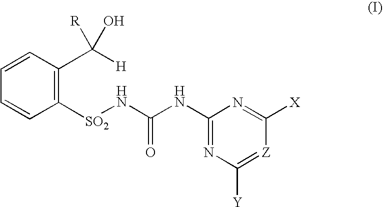

In addition, the present invention provides a method for the selective control of poaceae, cyperaceae and broadleaf weeds comprising treating a warm season turfgrass or a cool season turfgrass with the thiophene sulfonylurea derivative compounds represented by the following Formula (II), pre- or post-emergence.

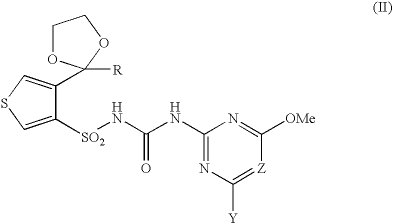

Effect of the Invention

According to the present invention, the compounds that are represented by the following Formula (I) or (II) have an excellent safety to a turf grass and herbicidal activity compared to existing sulfonylurea turf herbicides. As such, when applied to a turf grass, an excellent control effect can be obtained.

Embodiments for Carrying out the Invention

In order to achieve the purpose of the invention as described above, the present invention provides a method for the selective control of poaceae, cyperaceae and broadleaf weeds comprising treating a warm season turfgrass or a cool season turfgrass with the benzene sulfonylurea derivative compounds represented by the following Formula (I), pre- or post-emergence.

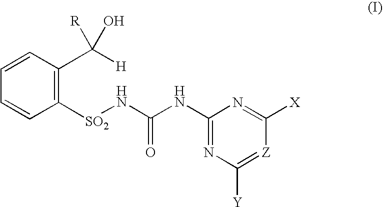

(wherein R indicates a haloalkyl group, X and Y, which are the same or different to each other, independently represent CH₃, OCH₃ or Cl and Z indicates CH or N).

Preferably, the benzene sulfonylurea derivative compounds represented by the above Formula (I) is N-[(4,6-dimethylpyrimidin-2-yl)aminocarbonyl-2-(2-fluoro-1-hydroxy-n-propyl)benzenesulfonamide.

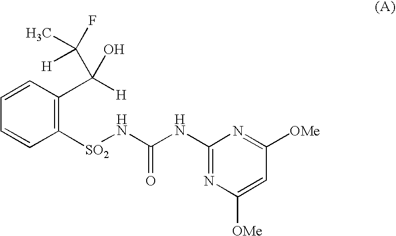

According to a method of one embodiment of the present invention, the warm season turfgrass is Korean field grass (Zoysia japonica) and the cool season turfgrass is bentgrass (Agrostris palustris), Kentucky blue grass (Poa pratensis), or perennial rye grass, but not limited thereto.

Further, in order to achieve the purpose of the invention as described above, the present invention provides a method for the selective control of poaceae, cyperaceae and broadleaf weeds comprising treating a warm season turfgrass or a cool season turfgrass with the thiophene sulfonylurea derivative compounds represented by the following Formula (II), pre- or post-emergence.

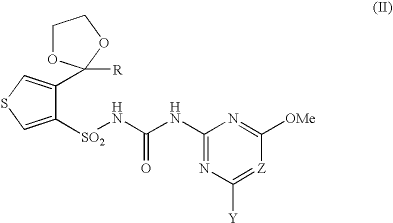

(wherein R indicates a C₁-C₆ alkyl group which is substituted with 1 to 3 halogen atoms, Y indicates CH₃ or OCH₃ and Z indicates CH or N).

Preferably, the benzene sulfonylurea derivative compounds represented by the above Formula (II) is 3-(2-fluoromethyl-1,3-dioxalan-2-yl)-N-[(4-methoxy-6-methyltriazin-2-yl)aminocarbonyl]4-thiophene sulfonamide.

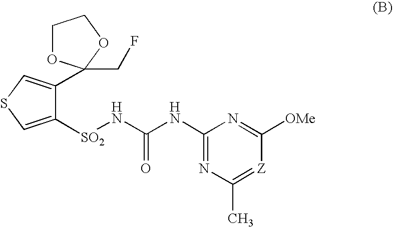

According to a method of one embodiment of the present invention, the warm season turfgrass is zoysiagrass (Zoysia japonica), but not limited thereto.

According to a method of one embodiment of the present invention, a turf grass herbicide comprising the derivative compounds of the Formula (I), the derivative compounds of the Formula (II), structure (A) of the Formula (I), or structure (B) of the Formula (II) may further comprise a solid carrier, a liquid carrier or a surfactant.

The solid carrier which can be comprised in the herbicide of the present invention includes the following: inorganic powder such as kaolin, bentonite, montmorilonite, talc, diatomite, mica, gypsum, calcium carbonate, apatite and silicon hydroxide; plant powder such as soybean flour, wheat flour, saw dust, tobacco powder, starch powder and crystalline cellulose; polymeric material such as petroleum resin, vinyl chloride resin and ketone resin; alumina; and wax.

The liquid carrier which can be comprised in the herbicide of the present invention includes the following: alcohols such as methanol, ethanol, ethylene glycol and benzyl alcohol; aromatic hydrocarbons such as benzene, toluene, xylene and methyl naphthalene; halogenated hydrocarbons such as chloroform, carbon tetrachloride and chlorobenzene; ethers such as dioxane and tetrahydrofuran; ketones such as acetone, methylethyl ketone and cyclohexanone; esters such as ethyl acetate, butyl acetate and ethylene glycol acetate; amides such as dimethylformamide; nitrites such as acetonitrile; ether alcohols such as ethyl glycol and ethyl ether; and water.

The surfactant which can be comprised in the herbicide of the present invention includes the following: cationic surfactants such as bromocetyltrimethyl ammonium salt; anionic surfactants such as alkyl aryl sulfonic acid, alkyloxy sulfonic acid, aryl sulfonic acid, alkaline metal salts, alkaline earth metal salts and ammonium salts thereof; and non-ionic surfactants such as aliphatic alcohols, castor oil, a condensate of naphthalene or naphthalene sulfonate and phenol or formaldehyde.

According to a method of one embodiment of the present invention, a turf grass herbicide preferably comprises the compounds of the Formula (I) or the compound of structure (A) as a single effective component in an amount of 1 to 80% by weight (w/w) based on the total weight of the final product. In addition, as an effective component included in a blend herbicidal agent, it is preferably comprised in an amount of 1 to 40% by weight (w/w) based on the total weight of the final product.

According to a method of other embodiment of the present invention, a turf grass herbicide preferably comprises the compounds of the Formula (II) or the compound of structure (B) as a single effective component in an amount of 1 to 80% by weight (w/w) based on the total weight of the final product. In addition, as an effective component included in a blend herbicidal agent, it is preferably comprised in an amount of 1 to 40% by weight (w/w) based on the total weight of the final product.

The compounds of the present invention can be used alone for eradicating noxious weeds, but also can be used as a blend herbicidal agent in combination with other known herbicides. Examples of a turf grass herbicide which can be used for a blend herbicidal agent include pendimethalin, benfluralin, ethalfluralin, oryzalin, prodiamine, dithiopyr, triaziflam, propyzamide, oxaziclomefone, napropamide, carfenstrole, oxadiargyl, benfuresate, ethofumesate, mecoprop, MCPP, asulam, endothal, metamifop, fluazifop-butyl, fenoxaprop-ethyl, fenoxaprop-P-ethyl, bispyribac-sodium, and pyribenzoxim.

In addition, it was confirmed that when the turf grass herbicides of the present invention are applied to a warm season turfgrass such as Korean field grass (Zoysia japonica) and the like or a cool season turfgrass such as bentgrass (Agrostris palustris), Kentucky blue grass (Poa pratensis), or perennial rye grass and the like, pre- or post-emergence, cyperaceae such as Poa annua, Digitaria sanguinalis, and the like, poaceae such as Cyperus rotundus, Kyllinga brevifolia, Cyperus amuricus and the like, and various kinds of broad leaf weeds such as clover, Erigeron canadensis, Hydrocotyle sibthorpioides, Kummerowia striata, Euphorbia humifusa, Viola arvensis and the like can be selectively controlled.

Herein below, the present invention is described in greater detail with reference to the following examples. However, they are only to exemplify the present invention and in no case it is construed that the present invention is limited thereto.

### EXAMPLES

### Example 1

### Preparation Comprising N-[(4,6-dimethylpyrimidin-2-yl)aminocarbonyl-2-(2-fluoro-1-hydroxy-n-propyl)benzenesulfonamide (Structure (A)) Herbicidal chemical

N-[(4,6-dimethylpyrimidin-2-yl)aminocarbonyl-2-(2-fluoro-1-hydroxy-n-propyl)benzenesulfonamide 10% (w/w)

Surfactant: a mixture comprising ethoxylated nonylphenol, monoether comprising ammonium sulfate salt (9051-57-4), sodium lignosulfonate (8061-51-6), silicon dioxide (7631-86-9) 10%

Auxiliary agent: silicon dioxide (7631-86-9) 5%

Extender: Pyrophilite SP, q.s.

The herbicidal chemical is pulverized by using a hammer mill, mixed with the surfactant, the auxiliary agent, and the extender, followed by pulverizing them again with a hammer mill to particle size of 100 micron or less. Resulting wettable agent is sifted through US No. 50 sieve and stored in an air-tight container.

### Example 2

### Preparation Comprising 3-(2-fluoromethyl-1,3-dioxalan-2-yl)-N-[(4-methoxy-6-methyltriazin-2-yl)aminocarbonyl]4-thiophene sulfonamide (Structure (B))

Herbicidal Chemical:

3-(2-fluoromethyl-1,3-dioxalan-2-yl)-N-[(4-methoxy-6-methyltriazin-2-yl)aminocarbonyl]4-thiophene sulfonamide 10% (w/w)

Surfactant: a mixture comprising ethoxylated nonylphenol, monoether comprising ammonium sulfate salt (9051-57-4), sodium lignosulfonate (8061-51-6), silicon dioxide (7631-86-9) 10%

Auxiliary agent: silicon dioxide (7631-86-9) 5%

Extender Pyrophilite SP, q.s.

The herbicidal chemical is pulverized by using a hammer mill, mixed with the surfactant, the auxiliary agent, and the extender, followed by pulverizing them again with a hammer mill to particle size of 100 micron or less. Resulting wettable agent is sifted through US No. 50 sieve and stored in an air-tight container

### Example 3

### Evaluation of Turf Grass Selectivity and Weed Spectrum

(1) Turf Grass Selectivity

Turf mats of Zoysia grass, bentgrass, Kentucky bluegrass, or perennial rye grass known as cool season turfgrass or western grass were purchased and cut into a piece having 10 cm×20 cm size. Then, each piece was transplanted in a rectangular plastic pot (surface area of 300 cm²) in which sandy loam and mixed top soil (Boo-Nong Top Soil No. 3, for horticultural use) are filled in 1:1 ratio. After the transplantation, the grasses were cut once a week to maintain the blade height at 0.5-1.0 cm and cultivated for one month in a green house of which temperature was kept at 25˜30° C. for daytime and 15˜25° C. for nighttime, respectively. Then, the ‘test chemical’ of the above Examples 1 and 2 or ‘control chemical’ was applied thereto in an amount of 400, 200, 100, 50, 25, 12, 6, 3 g ai/ha. As a “control chemical”, pyrazolsulfuron ethyl wettable agent (manufactured by Dongbu Fine Chemicals; herein after, referred to as ‘control chemical No. 1’) and flazasulfuron (manufactured by Dongbu HiTek; herein after, referred to as ‘control chemical No. 2’), both sulfonylurea herbicides for a turf grass, were used. Application was carried out by using a track sprayer (R&D Sprayer, USA) equipped with Teejet 8002 nozzle (Spraying Systems Co., USA), and the application amount was adjusted to 2,000 L/ha, which is a typical application amount for a golf course in Korea. Application solution was prepared by diluting the “test chemical” or the “control chemical” with tap water. Two or four weeks after the turf grass was treated with the above-prepared chemical solution, phytotoxicity to the turf grass was determined based on visual assessment (0 to 10 scale, 0 indicates no phytotoxicity and 10 indicates complete withering). The test was repeated three times in a random arrangement and the results are given in average value of each test (see Table 2 below).

TABLE 2
Evaluation of phytotoxicity of the test chemicals and the control
chemicals on a turf grass (visual assessment: 0 indicates no phytotoxicity and 10
indicates complete withering)

| | | Warm season | | | | | | | |
|---|---|---|---|---|---|---|---|---|---|
| | | turfgrass | | Cool season turfgrass | | | | | |
| | Application | Zoysia | | | | Kentucky | | Perennial | |
| | amount | japonica | | Bentgrass | | bluegrass | | rye grass | |
| Chemical | (g ai/ha) | 2 weeks | 4 weeks | 2 weeks | 4 weeks | 2 weeks | 4 weeks | 2 weeks | 4 weeks |
| Example 1 | 400 | 0 | 0 | 3 | 2 | 2 | 1 | 1 | 0 |
| | 200 | 0 | 0 | 2 | 1 | 1 | 0 | 0 | 0 |
| | 100 | 0 | 0 | 1 | 0 | 0 | 0 | 0 | 0 |
| | 50 | 0 | 0 | 0 | 0 | 0 | 0 | 0 | 0 |
| | 25 | 0 | 0 | 0 | 0 | 0 | 0 | 0 | 0 |
| | 12 | 0 | 0 | 0 | 0 | 0 | 0 | 0 | 0 |
| | 6 | 0 | 0 | 0 | 0 | 0 | 0 | 0 | 0 |
| | 3 | 0 | 0 | 0 | 0 | 0 | 0 | 0 | 0 |
| Example 2 | 400 | 4 | 3 | 10 | 10 | 10 | 10 | 10 | 10 |
| | 200 | 2 | 1 | 10 | 10 | 10 | 10 | 10 | 10 |
| | 100 | 1 | 0 | 10 | 10 | 10 | 10 | 10 | 10 |
| | 50 | 0 | 0 | 10 | 10 | 10 | 10 | 10 | 10 |
| | 25 | 0 | 0 | 10 | 10 | 10 | 10 | 10 | 10 |
| | 12 | 0 | 0 | 7 | 5 | 7 | 5 | 7 | 5 |
| | 6 | 0 | 0 | 5 | 3 | 5 | 3 | 5 | 3 |
| | 3 | 0 | 0 | 3 | 1 | 3 | 1 | 3 | 1 |
| Control | 400 | 0 | 0 | 3 | 1 | 2 | 1 | 1 | 0 |
| chemical No. 1 | 200 | 0 | 0 | 2 | 0 | 1 | 0 | 0 | 0 |
| | 100 | 0 | 0 | 1 | 0 | 0 | 0 | 0 | 0 |
| | 50 | 0 | 0 | 0 | 0 | 0 | 0 | 0 | 0 |
| | 25 | 0 | 0 | 0 | 0 | 0 | 0 | 0 | 0 |
| | 12 | 0 | 0 | 0 | 0 | 0 | 0 | 0 | 0 |
| | 6 | 0 | 0 | 0 | 0 | 0 | 0 | 0 | 0 |
| | 3 | 0 | 0 | 0 | 0 | 0 | 0 | 0 | 0 |
| Control | 400 | 7 | 6 | 10 | 10 | 10 | 10 | 10 | 10 |
| chemical No. 2 | 200 | 4 | 3 | 10 | 10 | 10 | 10 | 10 | 10 |
| | 100 | 2 | 2 | 10 | 10 | 10 | 10 | 10 | 10 |
| | 50 | 1 | 1 | 10 | 10 | 10 | 10 | 10 | 10 |
| | 25 | 0 | 0 | 10 | 10 | 10 | 10 | 10 | 10 |
| | 12 | 0 | 0 | 10 | 10 | 10 | 10 | 10 | 10 |
| | 6 | 0 | 0 | 10 | 10 | 10 | 10 | 10 | 10 |
| | 3 | 0 | 0 | 10 | 10 | 10 | 10 | 10 | 10 |

Control chemical No. 1: Pyrazosulfuron ethyl - wettable agent,
Control chemical No. 2: Flazasulfuron - wettable agent

According to the test results summarized in Table 2 above, Example 1, which corresponds to the test chemical of the present invention, has excellent safety to every kind of turf grasses tested at the application amount of 100 g ai/ha or less. Further, at the application amount of 400 or 200 g ai/ha, only minor phytotoxicity was observed. Such safety is almost at the same level as Control chemical No. 1.

Example 2, which also corresponds to the test chemical of the present invention, has high safety to Zoysia japonica at the application amount of 100 g ai/ha or less. However, for cool season turfgrass, there was significant phytotoxicity at the application amount of 25 g ai/ha or more so that the grasses were completely withered. Thus, the chemical was found not to be safe to the cool season turfgrass. Such tendency is similar to that found for Control chemical No. 2, i.e., application of Control chemical No. 2 in an amount of 50 g ai/ha or less is safe to Zoysia japonica but it was so toxic to every kind of the cool season turfgrass so that all the grasses were completely withered at the application amount as low as 3 g ai/ha. Thus, no selectivity was found. Compared to Control chemical No. 2, Example 2 of the present invention is relatively safe to Zoysia japonica and, and although not fully satisfying, its safety to the cold water turf grass is also recognized in an application amount of 10 g ai/ha or less. Taken together, overall safety of Example 2 to a turf grass is better than Control chemical No. 2.

(2) Weed Spectrum

To a rectangular plastic pot (surface area of 300 cm²) in which sandy loam and mixed top soil (Boo-Nong Top Soil No. 3, for horticultural use) are filled in 1:1 ratio, eight different kinds of weed seeds including Poa annua and Digitaria sanguinalis as poaceae weed, Cyperus amuricus as cyperaceae weeds and Trifolium repens, Kummerowia striata, fleabane, Veronica officinalis and Portulaca oleracea as broadleaf weeds were sewn (50 to 100 seeds per each weed). These weeds are representative examples of the weeds which typically thrive in a turf grass field.

The pot was kept in a greenhouse which was maintained at 25˜30° C. for daytime and 15˜25° C. for nighttime, respectively, and irrigation was carried out regularly. Fourteen days after seeding, when the turf grass and the weeds reached approximately at three-leaf stage, the weed seeds were again sewn in separate two pots or “Test chemical” and “Control chemical” were applied in the same manner as the method described above. In this regard, when plants were cultivated for two weeks and then the chemical application was carried out, it is designated as “post-emergence” treatment. On the other than, when the seeding was carried right before the chemical application, it is designated as “pre-emergence” treatment. Preparation of a chemical solution, application method, etc. are the same as above described for evaluation of turf grass selectivity. Two weeks after the chemical application, efficacy of the chemicals for each type of the weeds was evaluated (visual evaluation) based on 0 to 100 scale (i.e., 0 indicates no efficacy and 100 indicates complete weed control). Results are summarized in the following Table 3.

TABLE 3
Efficacy evaluation of the test chemicals and the control chemicals on
various type of turf grasses
(0 indicates no efficacy and 100 indicates complete weed control)

| | | Application amount | Digitaria | Poa | Trifolium | Kummerowia | | Veronica | Portulaca | Cyperus |
|---|---|---|---|---|---|---|---|---|---|---|
| Chemical | Application time | (g ai/ha) | sanguinalis | annua | repens | striata | Dandelion | officinalis | oleracea | amuricus |
| Example 1 | Pre-emergence | 100 | 100 | 80 | 70 | 100 | 100 | 50 | 100 | 100 |
| | | 50 | 100 | 70 | 70 | 90 | 100 | 40 | 100 | 100 |
| | | 25 | 85 | 60 | 50 | 90 | 90 | 30 | 90 | 95 |
| | | 12 | 60 | 50 | 30 | 70 | 90 | 30 | 90 | 90 |
| | Post-emergence | 100 | 100 | 70 | 60 | 100 | 100 | 20 | 100 | 100 |
| | | 50 | 90 | 50 | 60 | 100 | 100 | 20 | 100 | 100 |
| | | 25 | 70 | 30 | 50 | 70 | 90 | 20 | 90 | 95 |
| | | 12 | 60 | 10 | 40 | 70 | 90 | 20 | 70 | 90 |
| Example 2 | Pre-emergence | 100 | 100 | 90 | 90 | 100 | 100 | 50 | 100 | 60 |
| | | 50 | 100 | 90 | 70 | 90 | 100 | 40 | 100 | 50 |
| | | 25 | 95 | 60 | 60 | 90 | 90 | 30 | 90 | 30 |
| | | 12 | 95 | 50 | 30 | 70 | 90 | 30 | 90 | 20 |
| | Post-emergence | 100 | 100 | 95 | 60 | 100 | 100 | 20 | 100 | 50 |
| | | 50 | 90 | 90 | 60 | 100 | 100 | 20 | 100 | 50 |
| | | 25 | 70 | 80 | 50 | 70 | 90 | 20 | 90 | 40 |
| | | 12 | 40 | 60 | 40 | 70 | 90 | 20 | 70 | 30 |
| Control | Pre-emergence | 100 | 50 | 20 | 70 | 70 | 100 | 40 | 100 | 100 |
| chemical | | 50 | 30 | 20 | 70 | 50 | 90 | 30 | 70 | 100 |
| No. 1 | | 25 | 10 | 10 | 60 | 50 | 80 | 20 | 30 | 80 |
| | | 12 | 0 | 0 | 40 | 30 | 70 | 0 | 20 | 70 |
| | Post-emergence | 100 | 10 | 10 | 80 | 50 | 100 | 30 | 80 | 100 |
| | | 50 | 0 | 0 | 70 | 40 | 100 | 30 | 60 | 80 |
| | | 25 | 0 | 0 | 60 | 30 | 90 | 20 | 40 | 70 |
| | | 12 | 0 | 0 | 20 | 0 | 80 | 10 | 20 | 50 |
| Control | Pre-emergence | 100 | 100 | 100 | 100 | 100 | 70 | 60 | 100 | 100 |
| chemical | | 50 | 90 | 100 | 100 | 100 | 50 | 50 | 90 | 80 |
| No. 2 | | 25 | 70 | 70 | 80 | 90 | 40 | 30 | 60 | 70 |
| | | 12 | 60 | 40 | 70 | 80 | 30 | 20 | 40 | 40 |
| | Post-emergence | 100 | 80 | 90 | 100 | 100 | 50 | 40 | 100 | 80 |
| | | 50 | 80 | 80 | 100 | 100 | 40 | 30 | 90 | 80 |
| | | 25 | 70 | 70 | 100 | 90 | 30 | 20 | 90 | 70 |
| | | 12 | 50 | 40 | 80 | 80 | 10 | 10 | 80 | 60 |

As a result of efficacy test against various types of weeds which thrive in a turf grass field, Example 1 showed 80 to 100% control activity both for pre-emergence and post-emergence treatment of all kinds of the weed tested including poaceae weeds such as Digitaria sanguinalis, Poa annua, etc. at the application amount of 50˜100 g ai/ha, except Veronica officinalis. Meanwhile, according to the above-described turf grass selectivity test, Example 1 showed only minor phytotoxicity to a turf grass at the application amount as high as 400 g ai/ha, and there was no phytotoxicity at all at 100 g ai/ha. Thus, it is clear that when the test chemical of Example 1 is applied in amount of 50˜100 g ai/ha, most weeds can be controlled while both warm season turfgrass and cool season turfgrass are safely maintained.

According to the above-described turf grass selectivity test, safety of the test chemical of Example 1 is similar to that of the Control chemical No. 1. In terms of efficacy for controlling broadleaf weeds and cyperaceae weeds, Control chemical No. 1 is almost the same as Example 1. However, for Digitaria sanguinalis, Poa annua as poaceae weeds, there was almost no weed control effect (i.e., only 20 to 50% at the highest application amount of 100 g/ha). Thus, for controlling poaceae weeds, Control chemical No. 1 should be used in combination with other herbicides that are useful for controlling them. On the other hand, the test chemical of Example 1 of the present invention is clearly distinguished in that it can control poaceae weeds, which cannot be controlled by Control chemical No. 1, while safety to various kinds of a turf grass remains almost at the same level as Control chemical No. 1. In a real grass field, control of broadleaf grasses is not so difficult since they are usually controlled by other herbicides or by frequent mowing. On the other hand, poaceae weeds, which have morphology and growth characteristic similar to a turf grass, should be controlled more carefully.

Compared to Example 1, Example 2 showed better control effect against poaceae weeds such as Digitaria sanguinalis and Poa annua. Specifically, when applied in an amount of 50 to 100 g/ha, at least 90% of Digitaria sanguinalis and Poa annua was controlled. For Trifolium repens, Veronica officinalis, Cyperus amuricus, it showed slightly weaker control effect compared to Example 1. For the remaining weeds, the control effect was almost the same.

Since Example 2 exhibited satisfying safety to the warm season turfgrass similar to Control chemical No. 2, it can be said that it has almost the same control effect against Digitaria sanguinalis and Poa annua while control effect against dandelion is better compared to Control chemical No. 2. Meanwhile, it showed poorer control effect against Cyperus amuricus and Trifolium repens compared to Control chemical No. 2, which is mostly used for controlling Poa annua than other weeds. Poa annua has similar characteristics as cool season turfgrass and is one of the most difficult weeds to be controlled by a herbicidal chemical. For such reasons, in spite of phytotoxicity to a turf grass, Control chemical No. 2 is often used as a herbicide. In this regard, since the test chemical of Example 1 has an activity of controlling Poa annua almost the same level as Control chemical No. 2 and has satisfying safety to warm season turfgrass, it can be used as an herbicidal agent exclusively for controlling Poa annua in warm season grass field.

Over the world, a golf course is very important for turf grass market. In Korea and Japan, fairways are mostly consist of warm season turfgrass so that Control chemical No. 2 is often employed for controlling Poa annua. However, in putting greens or tee box area, cool season turfgrass such as bentgrass, and Kentucky bluegrass, etc. are used. When Control chemical No. 2, which has been applied to a fairway, is carried by shoes and tools of a golfer or a field worker, putting greens or a tee box area can be severely damaged by the chemicals. Thus, use of Control chemical No. 2 is not allowed within the 100 m distance from putting green. Although the amount of Control chemical No. 2 which can be transferred from a fairway to putting green is usually very small, it is still able to cause severe damage to the putting green, since it can cause complete withering of cool season turfgrass at extremely small amount of 3 g/ha, as shown in the above Table 2. Meanwhile, although there is not enough safety for direct application to cool season turfgrass, test chemical of Example 2 has significantly higher safety at small application amount such as 10 g/hr or less compared to Control chemical No. 2. As such, when the test chemical of Example 2 is applied to warm season turfgrass to control weeds such as Poa annua, etc., risk of causing damages to putting greens or tee box due to its transfer by a golfer or field worker is significantly reduced. Therefore, although the test chemical of Example 2 is used only for warm season turfgrass like Control chemical No. 2, risk of causing damages to neighboring cool season turfgrass is dramatically low. Thus, as having less limitation in use compared to Control chemical No. 2, the test chemical of Example 2 of the present invention may provide a field applicators with greater convenience.

### Example 4

### Test Results of Example 1 in an Actual Field Condition

The test chemical of the Example 1 was applied to a turf grass field, in which Digitaria sanguinalis as a representative summer-time poaceae weed and Kyllinga brevifolia as a representative hard-to-control perennial cyperaceae weed are thriving predominantly, to evaluate weed control effect of the compound. The experiment was carried out from May to July, 2008 in the Dae-duk Research Park golf course (Doryong-dong, Yusong-gu, Daejon, South Korea). At the time of the chemical application, Digitaria sanguinalis was at about 4-leaf stage and Kyllinga brevifolia was at growth period. Results obtained twenty days after the chemical application are summarized in Table 4.

TABLE 4
Effect of Example 1 in an actual field condition
(0 indicates no efficacy/phytotoxicity and 10 indicates complete withering)

| | Applica- | | | | |
|---|---|---|---|---|---|
| | tion | | | | |
| Test | amount | Zoysia | Kentucky | Digitaria | Kyllinga |
| chemical | (g ai/ha) | japonica | bluegrass | sanguinalis | brevifolia |
| Example 1 | 200 | 0 | 0 | 100 | 100 |
| | 100 | 0 | 0 | 90 | 100 |
| | 50 | 0 | 0 | 80 | 100 |
| Control | 100 | 0 | 0 | 20 | 60 |
| chemical | | | | | |
| No. 1 | | | | | |

As shown in Table 4, the test chemical of the Example 1 have absolutely no phytotoxicity not only to Zoysia japonica but also to Kentucky bluegrass at the application amount of 200 g/ha. However, 80% of Digitaria sanguinalis was controlled and 100% of Kyllinga brevifolia was controlled at 50 g ai/ha or more. On the contrary, the Control chemical No. 1 has almost no effect against Digitaria sanguinalis and there was only an insufficient effect against Kyllinga brevifolia.

Consequently, it is verified that by using the test chemical of the Example 1 in an amount of 50-100 g/ha, a weed control effect which is significantly higher than the Control chemical No. 1 can be obtained.

### Example 5

### Test Results of Example 2 in an Actual Field Condition

The test chemical of the Example 2 was applied to a turf grass field, in which Viola arvensis as a representative hard-to-control perennial weed is thriving predominantly, to evaluate a weed control effect of the compound. The experiment was carried out from May to June, 2007 in the turf grass field within Korea Research Institute of Bioscience and Biotechnology (52, Ueun-dong, Yusong-gu, Daejon, South Korea). Fourteen days after the chemical application, the turf grass was cut once. Results are summarized in Table 5.

TABLE 5
Effect of Example 2 in actual field condition
(0 indicates no efficacy/phytotoxicity and 10 indicates complete withering)

| | | Phytotoxicity | | | |
|---|---|---|---|---|---|
| | | on Zoysia | | | |
| | application | japonica | Effect on Viola arvensis | | |
| | amount | After | After | After | After |
| Test chemical | (g ai/ha) | 14 days | 7 days | 14 days | 30 days |
| Example 2 | 50 | 0 | 20 | 50 | 95 |
| Control | 50 | 0 | 20 | 50 | 30 |
| chemical No. 2 | | | | | |

As shown in Table 5, chemicals of the Example 2 and Control chemical No. 2 have no phytotoxicity to Zoysia japonica at the application amount of 50 g/ha. Viola arvensis is a hard-to-control weed which is not easily controlled by typical herbicides. Until the fourteenth days after the application, no significant effect was shown other than slight control. However, after mowing them once, there was no re-growth of the weeds when the field was treated with the chemical of the Example 2, indicating almost perfect weed control. On the other hand, for the Control chemical No. 2, Viola arvensis was growing back after the cutting, and there was almost no control effect after 30 days.

As such, it is verified that by using the test chemical of the Example 2 of the present invention in an amount of 50 g/ha, a weed control effect which is significantly higher than the Control chemical No. 2 can be obtained.

What is claimed is:

1. A method for the selective control of poaceae, cyperaceae and broadleaf weeds in a warm season turfgrass or a cool season turfgrass with the benzene sulfonylurea derivative compounds represented by the following Formula (I), pre- or post-emergence. 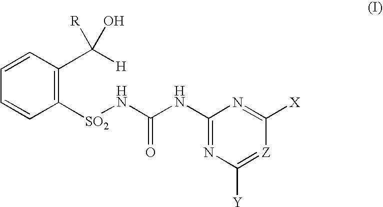
(wherein R indicates a haloalkyl group, X and Y, which are the same or different to each other, independently represent CH₃, OCH₃ or Cl and Z indicates CH or N).

2. A method for the selective control of poaceae, cyperaceae and broadleaf weeds in a warm season turfgrass or a cool season turfgrass with the thiophene sulfonylurea derivative compounds represented by the following Formula (II), pre- or post-emergence. 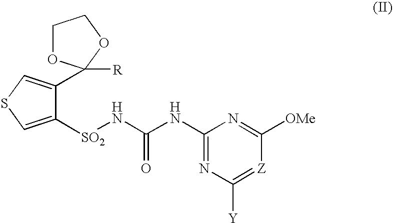
(wherein R indicates a C₁-C₆ alkyl group which is substituted with 1 to 3 halogen atoms, Y indicates CH₃ or OCH₃ and Z indicates CH or N).

3. The method according to claim 1, characterized in that the compound represented by the Formula (I) is N-[(4,6-dimethylpyrimidin-2-yl)aminocarbonyl-2-(2-fluoro-1-hydroxy-n-propyl)benzenesulfonamide that is represented by the following structural formula (A).

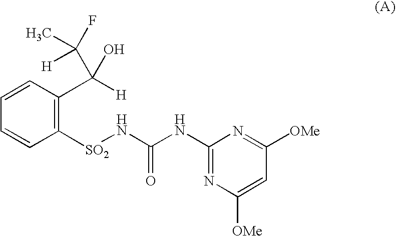

4. The method according to claim 1, characterized in that the compound represented by the Formula (II) is 3-(2-fluoromethyl-1,3-dioxalan-2-yl)-N-[(4-methoxy-6-methyltriazin-2-yl)aminocarbonyl]4-thiophene sulfonamide that is represented by the following structural formula (B). [chemical structure]
